(19) United States
(12) Patent Application Publication
(10) Pub. No.: US 2020/0041874 A1
(43) Pub. Date: Feb. 6, 2020

(54) IMAGING DEVICE

(71) Applicant: NIDEC COPAL CORPORATION, Tokyo (JP)

(72) Inventor: Yuta NAKAMURA, Tokyo (JP)

(73) Assignee: NIDEC COPAL CORPORATION, Tokyo (JP)

(21) Appl. No.: 16/498,526

(22) PCT Filed: Mar. 30, 2018
(86) PCT No.: PCT/JP2018/013587

§ 371 Date: Sep. 27, 2019

(30) Foreign Application Priority Data
Mar. 31, 2017 (JP) 2017-069425

(51) Int. Cl. G03B 17/08; G02B 7/02

(52) U.S. Cl. CPC G03B 17/08; H04N 5/2252; G02B 7/021; G02B 7/022

(57) ABSTRACT

An imaging device, having a lens barrel for holding a lens group; a lens flange that is connected to the lens barrel; a front case; a rear case, disposed further in the optical axial rearward direction than the front case, for containing the lens barrel together with the front case; a waterproofing seal, disposed between the front case and the lens flange, between the rear case and the lens flange, or between the lens barrel and the lens flange; and a coupling for connecting together the front case, the rear case, and the lens flange, at a position that is to the outside, in respect to the optical axis, of the waterproofing seal.

### CROSS-REFERENCE TO RELATED APPLICATIONS

This Application is a National Stage of International Application No. PCT/JP2018/013587 filed Mar. 30, 2018 which claims priority to Japanese Application No. 2017-069425 Mar. 31, 2017. Both of which are incorporated herein in their entirety.

### FIELD OF TECHNOLOGY

One aspect of the present invention relates to an imaging device.

### BACKGROUND

Among imaging devices wherein a lens barrel and a substrate for mounting an imaging element are contained within a case, vehicle-mounted cameras, security cameras, and the like, must be structured with high waterproofing performance because they are to be deployed outdoors. In this case, a structure that provides waterproofing, through providing a waterproofing seal (a waterproofing packing) between the lens barrel and the case is used. Japanese Unexamined Patent Application Publication 2015-68891 discloses a camera case structure that is structured through the provision of a waterproofing seal. On the other hand, Japanese Unexamined Patent Application Publication 2013-37189 discloses a vehicle-mounted camera that improves the waterproofing performance through welding, rather than using a waterproofing packing.

### SUMMARY

However, in an imaging device that is configured to the provision of a waterproofing seal (or waterproofing packing), there is the possibility that a liquid, such as water, can enter into the inside of the case, through, for example, degradation of the waterproofing seal over time. Moreover, sometimes attempts to satisfy adequate waterproofing performance end up using a plurality of waterproofing seals, or a structure that increases the number of coupling parts, increasing the number of components. On the other hand, while it is possible to improve the waterproofing performance while reducing the number of parts through a structure that improves the waterproofing performance through welding, the manufacturing process would be more complex, leading to higher costs.

The present invention adopts means such as the following in order to solve the problem described above. Note that while in the explanation below, reference symbols from the drawings are written in parentheses for ease in understanding the present invention, the individual structural elements of the present invention are not limited to those that are written, but rather should be interpreted broadly, in a range that could be understood technically by a person skilled in the art.

One example according to the present invention is an imaging device, including a lens barrel (2) for holding a lens group; and a lens flange (4) that is connected to the lens barrel; a front case (1); a rear case (8), disposed further in the optical axial rearward direction than the front case, for containing the lens barrel together with the front case; a waterproofing seal (3, 7), disposed between the front case and the lens flange, between the rear case and the lens flange, or between the lens barrel and the lens flange; and a coupling (62) for connecting together the front case, the rear case, and the lens flange, at a position that is to the outside, in respect to the optical axis, of the waterproofing seal.

In the imaging device structured as described above, the front case, the rear case, and the lens flange are connected together as a group, and because they are connected at a position that is to the outside of the waterproofing seal, this can suppress incursion of liquid to the position of the waterproofing seal, which can improve waterproofing performance. Moreover, because the front case, the rear case, and the lens flange are connected together as a group, this can reduce the number of components when compared to a structure wherein each is connected through an individual coupling.

In the imaging device set forth above the rear case (8) has a first connecting hole (8a); the lens flange (4) has a second connecting hole (4a); the front case (1) has a coupling groove (1a); and the coupling (62) passes through the first connecting hole and the second connecting hole, and is inserted into the coupling groove.

In the imaging device structured as described above, the coupling is used to connect together the front case, the rear case, and the lens flange as a group, enabling a structure that has adequately high waterproofing performance well being of a relatively easy structure, while reducing the number of components.

In the imaging device set forth above the lens barrel and the lens flange are separate members; and the waterproofing seal (3) is disposed between the lens barrel and the lens flange.

The imaging device structured as described above enables the relative positioning of the lens barrel and the lens flange in the optical axial direction to be adjusted, through having the lens barrel and the lens flange be separate members. This makes it possible to have a structure wherein the focusing adjustment can be carried out easily. Moreover, because a waterproofing seal is disposed between the lens of flange and the lens barrel, incursion of liquid, such as water, into the coupling part between the lens barrel and the lens flange can be suppressed.

In the imaging device set forth above the waterproofing seal (3) is disposed between the lens barrel and the lens flange in the optical axial direction.

The imaging device structured as described above enables a structure that produces the waterproofing effects through the waterproofing seal while suppressing positional shift that occurs between the lens barrel and the lens flange in the optical axial direction. Moreover, it is possible to structure with excellent waterproofing performance through the waterproofing seal being compressed, in the optical axial direction, by the lens barrel and the lens flange.

In the imaging device set forth above the lens barrel has a recessed portion or a protruding portion on the outside in the radial direction.

The imaging device structured as described above enables the lens barrel to be rotated through the recessed portion or the protruding portion, enabling an improvement in the ease of operation for adjusting the focus or adjusting the rotational position.

In the imaging device set forth above the recessed portion or the protruding portion of the lens barrel is covered by the front case.

The imaging device structured as described above enables structuring with excellent ease of operation in adjusting the focus or adjusting the rotational position, in a state wherein the recessed portion or protruding portion cannot be seen from the outside. This enables an imaging device with superior external appearance.

The imaging device set forth above further has a bracket (9) that is connected to an external device, wherein the coupling connects together the bracket, along with the front case, the rear case, and the lens flange.

The imaging device structured as set forth above enables a structure that prevents an increase in the number of components, while enabling connection to the device to which the imaging device is to be connected.

### BRIEF DESCRIPTIONS OF THE DRAWINGS

FIG. 1 is an exterior perspective diagram of an imaging device according to an example, viewed from the front side.

FIG. 2 is an exterior perspective diagram of an imaging device according to the example, viewed from the rear side.

FIG. 3 is an assembly perspective diagram of an imaging device according to the example, viewed from the front side.

FIG. 4 is an assembly perspective diagram of an imaging device according to the example, viewed from the rear side.

FIG. 5 is a cross-sectional diagram of the imaging device according to the example.

FIG. 6 is a perspective diagram wherein the state wherein the lens barrel and the lens flange of the example are connected, viewed from the front side.

FIG. 7 is a perspective diagram wherein the state wherein the lens barrel and the lens flange of the example are connected, viewed from the rear side.

FIG. 8 is an exterior perspective diagram of an imaging device according to another example, viewed from the front side.

FIG. 9 is an exterior perspective diagram of an imaging device according to the another example, viewed from the rear side.

FIG. 10 is an assembly perspective diagram of an imaging device according to the another example, viewed from the front side.

FIG. 11 is an assembly perspective diagram of an imaging device according to the another example, viewed from the rear side.

FIG. 12 is a cross-sectional diagram of the imaging device according to the another example.

### DETAILED DESCRIPTION

One distinctive feature of the imaging device according to the present invention is a structure wherein the front case, the rear case, and the lens flange are connected together as a group by the coupling, and the waterproofing seal is disposed further toward the inside, in respect to the optical axis, than the coupling position.

In this Specification, the position of the center of the lens, that is, the position of the center of the light that is incident into the imaging element, is termed the “optical axis.” The object that is imaged, positioned on the side of the lens that is opposite from the imaging element, will be termed the “imaging subject.” The direction in which the imaging subject is position, in respect to the imaging element, will be termed the “front side” or “optical axial forward direction,” and the direction at which the imaging element is positioned, in respect to the imaging subject, will be termed the “rear side” or “optical axial rearward direction.”

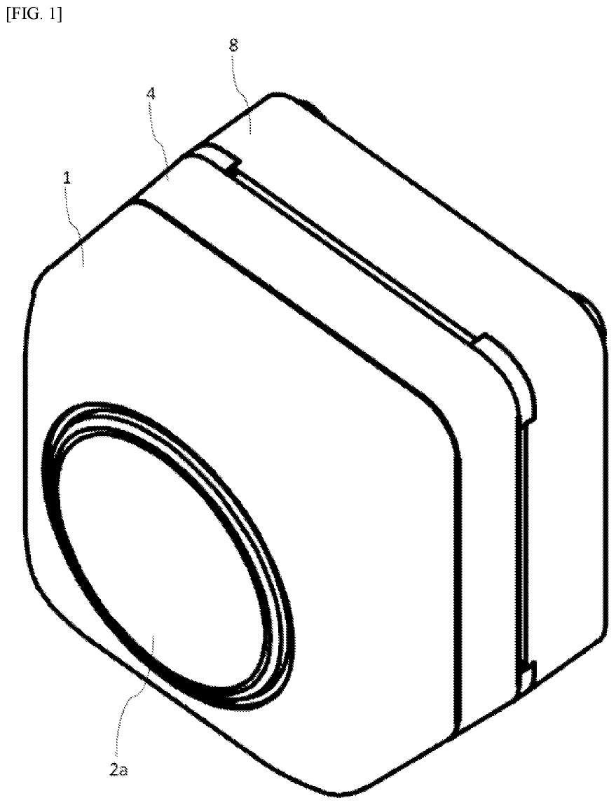

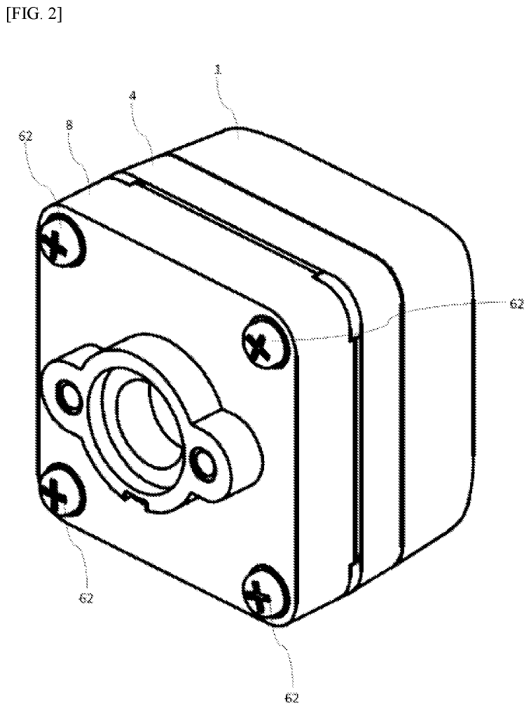

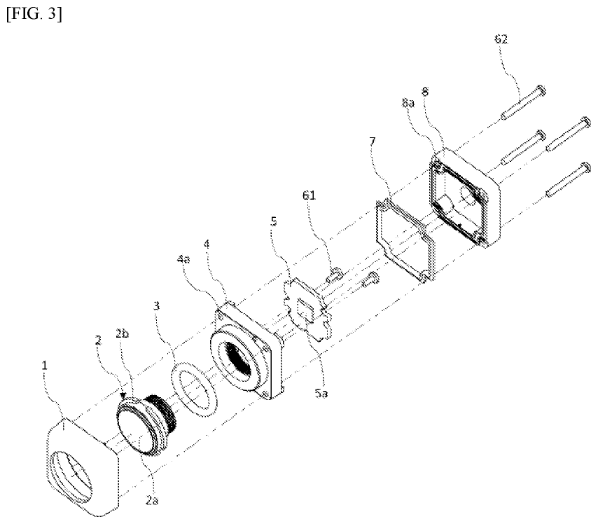

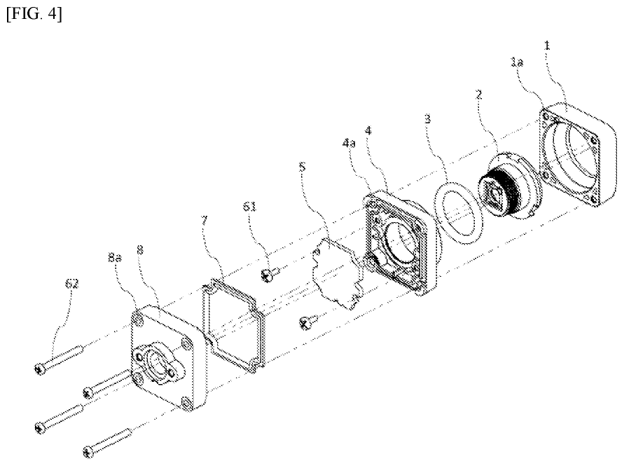

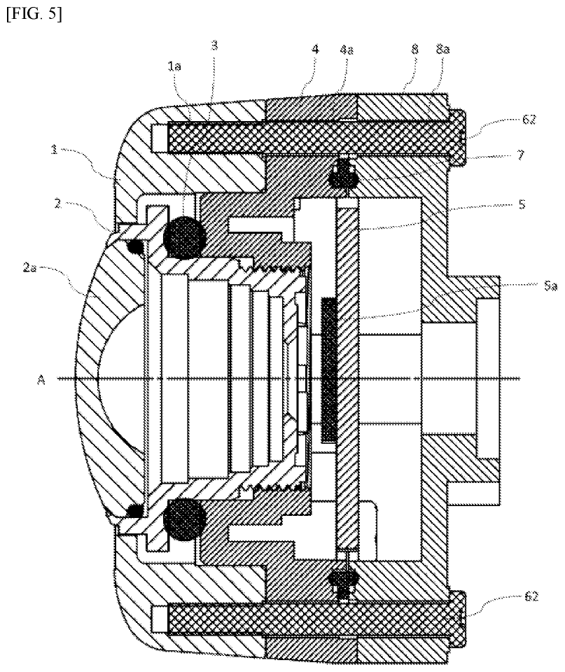

An example according to the present invention will be explained following the structures below. However, the example explained below is no more than an example of the present invention, and must not be interpreted as limiting the technical scope of the present invention. Note that in the various drawings, identical reference symbols are assigned to identical structural elements, and explanations thereof may be omitted. An example according to the present invention will be explained in reference to the drawings. FIG. 1 and FIG. 2 are exterior perspective diagrams of an imaging device according to the present example, wherein FIG. 1 is a diagram seen from the front side and FIG. 2 is a diagram seen from the rear side. FIG. 3 and FIG. 4 are perspective assembly diagrams of an imaging device according to the present example, wherein FIG. 3 is a diagram seen from the front side and FIG. 4 is a diagram seen from the rear side. FIG. 5 is a cross-sectional diagram of the imaging device according to the present example. “A” shown in the figure indicates the optical axis.

As depicted in FIG. 1 through FIG. 5, an imaging device according to the present example is structured including a front case 1, a lens barrel 2, a waterproofing seal 3, a lens flange 4, a substrate 5, a waterproofing seal 7, a rear case 8, and couplings 61 and 62.

<Front Case 1>

The front case 1 is a member for forming the case of the imaging device, together with the rear case 8, which is disposed to the rear in the optical axial direction, and is formed from resin, or the like. The lens flange 4 is disposed so as to be held between the front case 1 and the rear case 8. The front case 1 has an opening portion, centered on the optical axis, in the optical axial forward direction, and, in the optical axial rearward direction, is open, so as to be able to connect to the lens flange 4 rear case 8, and has side faces have essentially a rectangular shape in the cross-section thereof, so as to cover the optical axis. A space for containing the lens barrel 2, the substrate 5, and the like, is formed through connecting together the front case 1, the lens flange 4, at the rear case 8. As depicted in FIG. 1, a lens 2a, which is held by the lens barrel 2, is positioned at an opening portion, in the optical axial forward direction, of the front case 1, and the inner radius of the front case 1 and the outer radius of the lens barrel 2 are fitted radially. As depicted in FIG. 4 and FIG. 5, the front case 1 has a coupling groove 1a into which the coupling 62 is inserted, at a position that is further to the outside, in respect to the optical axis, than the waterproofing seal 3 and the waterproof seal 7. The coupling groove 1a is a groove-shaped part that is formed extending in a direction that is the horizontal (i.e. parallel) to the optical axis, from the optical axial rearward direction toward the front.

<Rear Case 8>

The rear case 8 is disposed further toward the optical axial rearward direction than the front case 1 and the lens flange 4. As described above, the rear case 8 forms a space for containing the lens barrel 2, the substrate 5, and the like, through coupling with the front case 1 and the lens flange 4. The rear case 8 is a plate-shaped member having a surface that is essentially perpendicular to the optical axis. As depicted in FIG. 3, FIG. 4, and FIG. 5, the rear case 8 has a connecting hole 8a into which the coupling 62 is inserted, at a position that is further to the outside, in respect to the optical axis, then the waterproofing seal 3 and the waterproofing seal 7. The connecting hole 8a is a through hole that extends in a direction that is horizontal (i.e. parallel) to the optical axis. The rear case 8 is connected to the lens flange 4 and the front case 1 through a coupling 62 that is inserted into the connecting hole 8a from the optical axial rearward direction. Note that the connecting hole 8a is an example of a “first connecting hole” of the present invention.

<Lens Barrel 2>

The lens barrel 2 is a cylindrical member that extends in the optical axial direction, and holds one or more optical members, including the lens 2a. Optical members held in the lens barrel 2 include, in addition to the lens 2a, lenses, spacers, aperture plates, optical filters, and the like. The lens that includes the lens 2a is formed from a raw material that has transparency, such as glass, plastic, or the like, and refracts and transmits, in the optical axial rearward direction, the light from the optical axial forward direction. The spacers are flat annular ring-shaped members having an appropriate thickness in the optical axial direction, to adjust the positions of the individual lenses in the optical axial direction. The spacers have opening portions in the center portions thereof, including the optical axis. The aperture plate determines the outermost position of the light that passes therethrough. The optical filters suppress or block light of prescribed wavelengths. Optical filters include, for example, infrared radiation cut filters that reduce the infrared radiation that passes therethrough. The number of these optical members can be changed arbitrarily.

The lens barrel 2 engages, through screw-fitting, with the lens flange 4, which is disposed in the optical axial rearward direction. Screw threads are formed on the radial outside of the lens barrel 2, and screw together with screw threads of the lens flange 4. The lens barrel 2 is inserted, in respect to the lens flange 4, through rotation in respect to the lens flange 4. That is, the relative positioning with the lens flange 4 in the optical axial direction changes depending on the amount to which the lens barrel 2 is screwed into the lens flange 4. That is, the lens barrel 2 and the lens flange 4 are screwed together. Note that the lens barrel 2 in the lens flange 4 may be cam-fitted instead of screw-fitted.

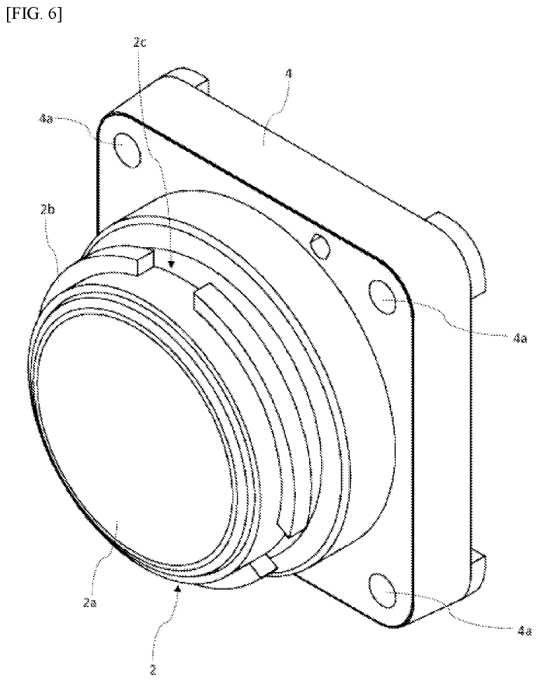

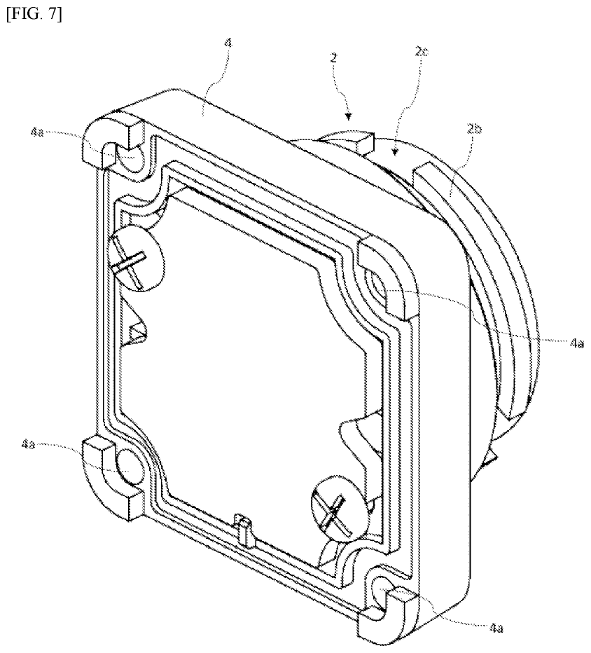

FIG. 6 and FIG. 7 are perspective diagrams depicting the state wherein the lens barrel 2 and the lens flange 4 are coupled together; FIG. 6 is a diagram when viewed from the front side; and FIG. 7 is a diagram when viewed from the rear side. As shown primarily in FIG. 6 and FIG. 7, the lens barrel 2 has a protruding portion 2b that extends in a ring shape to the outside in the radial direction. The protruding portion 2b has a notch portion 2c at a prescribed position in the circumferential direction, where a catch portion for catching hardware that is used for adjusting the focus is formed thereby. When adjusting the position of the lens barrel 2 in respect to the imaging element 5a, the hardware being caught by the catch portion, which comprises the protruding portion 2b and the notch portion 2c, rotates the lens barrel 2, changing the amount to which the lens barrel 2 is screwed into the lens flange 4. The protruding portion 2b and notch portion 2c of the lens barrel 2 are covered by the front case 1 so as to not be visible to the outside in a state wherein the imaging device is assembled.

<Waterproofing Seal 3>

The waterproofing seal 3 is a circular ring-shaped member formed from an elastic material such as rubber, and is disposed between the lens barrel 2 and the lens flange 4 in the optical axial direction (referencing FIG. 5). The waterproofing seal 3 is supported by the lens barrel 2 and the lens flange 4 while being compressed, in the optical axial direction, by the lens barrel 2 and the lens flange 4.

<Lens Flange 4>

The lens flange 4 is a member that is disposed in the optical axial rearward direction of the lens barrel 2. The lens flange 4 is connected to the lens barrel 2 through screwing, through the lens barrel 2 being inserted into the radial-direction inside thereof. As depicted in FIG. 3 through FIG. 7, the lens flange 4 has a connecting hole 4a into which the coupling 62 is inserted, at a position that is to the outside, in respect to the optical axis, of the waterproofing seal 3 and the waterproofing seal 7. The connecting hole 4a is a through hole that extends in a direction that is horizontal (i.e. parallel) to the optical axis. The lens flange 4 is connected to the rear case 8 and the front case 1 by the coupling 62. Note that the connecting hole 4a is an example of a second connecting hole” in the present invention.

Note that the lens flange 4 and the lens barrel 2 may instead be formed as a single unit. In such a case, the connecting portion between the lens flange 4 in the lens barrel 2 would be omitted, and the waterproof seal 3, for eliminating a gap through which water, or the like, could enter, would be unnecessary. In this Specification, the expression that “the lens flange 4 and the lens barrel 2 are connected,” includes both the lens flange 4 and the lens barrel 2 being structured as a single unit, and the case wherein they are separate units and are connected together through a coupling, or the like.

<Substrate 5>

The substrate 5 is a rigid substrate upon which are mounted electronic components, including the imaging element 5a. An imaging element 5a and electronic elements are installed on the substrate 5. The substrate 5 is connected to the lens flange 4 through the coupling 61. The electric signals acquired from the imaging element 5a are subjected to prescribed electronic processing or signal processing by the electronic components that are mounted on the substrate 5, and then outputted as image data to outside of the imaging device.

The imaging element 5a is a photoelectric converting element for converting the incident light into electric signals, and is, for example, a CMOS sensor, a CCD, or the like, although there is no limitation thereto. Moreover, in the imaging device, an imaging portion other than the imaging element 5a, having an imaging function, may be used instead. The imaging element may be a portion, other than an imaging element described above, able to perform imaging, and may be termed an “imaging portion.”

<Waterproofing Seal 7>

The waterproofing seal 7 is a member that is formed from an elastic material such as rubber, as with the waterproofing seal 3, and is disposed between the lens flange 4 and the rear case 8, to connect the lens flange 4 and the rear case 8 without a gap. The waterproofing seal 7 has a shape corresponding to the connecting surface of the lens flange 4 and the rear case 8, where the waterproofing seal 7 in the present example is a rectangle with a corner portion cutaway. The coupling 62 is inserted into a position that is cut away at the corner portion of the waterproof seal 7.

Note that the structure may be one equipped with a waterproofing seal between the front case 1 and the lens flange 4, instead of the waterproofing seal 7 or in addition to the waterproofing seal 7. In this case as well, preferably the positioning is nearer to the optical axis than the coupling 62, in the same manner as with the waterproofing seal 7, in order to produce a strong waterproofing effect.

<Coupling 62>

The coupling 62 is, for example, a screw, and is inserted from the optical axial rearward direction through the connecting hole 8a of the rear case 8 and the connecting hole 4a of the lens flange 4 into the coupling groove 1a of the front case 1. The coupling 62 connects together the front case 1, the rear case 8, and the lens flange 4, as a group, at a position that is further to the outside, in respect to the optical axis, than the waterproofing seal 3 and the waterproofing seal 7. Note that the coupling 62 may instead be a coupling such as a pin, instead of a screw.

As described above, the imaging device according to the present example is structured through connecting together the front case 1, the rear case 8, and the lens flange 4 through a coupling 62 that is disposed further to the outside, in respect to the optical axis, than the waterproofing seal 7 (and waterproofing seal 3). This configuration enables suppression of incursion of a liquid, such as water, from the outside, to the position of the waterproofing seal 7 (and waterproofing seal 3). This enables prevention of degradation of the waterproofing seal 7 (and waterproofing seal 3) over time. Moreover, this enables a structure that can produce adequate waterproofing effects despite degradation over time in the waterproofing seal 7 (or waterproofing seal 3). Moreover, because the front case 1, the rear case 8, and the lens flange 4 are connected together as a group by the coupling 62, this can reduce the number of components when compared to a structure where each is connected through an individual coupling.

Moreover, the imaging device according to the present example is structured with the coupling 62 inserted through the connecting hole 8a of the rear case 8 and the connecting hole 4a of the lens flange 4 into the coupling groove 1a of the front case 1. This structure enables coupling of the front case 1, the rear case 8, and the lens flange 4 through a relatively simple structure while reducing the number of components in the imaging device according to the present example. This enables a structure that has adequate waterproofing performance.

Moreover, in the imaging device according to the present example, if the structure is such that the lens barrel 2 and the lens flange 4 are separate members, the waterproofing seal 3 is disposed therebetween. This enables the relative positioning between the lens barrel 2 and the lens flange 4 in the optical axial direction to be adjusted, enabling a structure wherein the focus can be adjusted easily. Additionally, because the waterproofing seal 3 is disposed between the lens barrel 2 and the lens flange 4, this enables suppression of incursion of liquid, such as water, at the coupled part of the lens barrel 2 and the lens flange 4.

Additionally, in the imaging device according to the present example, the waterproofing seal 3 is disposed between the lens barrel 2 and the lens flange 4, thus enabling a structure wherein the waterproofing effects can be achieved easily while securing the lens barrel 2 and the lens flange 4 with stability, with no gap therebetween in the optical axial direction. Moreover, because the waterproofing seal 3 is held while being compressed in the optical axial direction, this enables a structure with high waterproofing performance.

Moreover, in the imaging device according to the present example, the lens barrel 2 has a catch portion that is structured from a protruding portion 2b and a notch portion 2c on the outside in the radial direction. This structure enables a structure wherein, in the assembly process, the lens barrel 2 can be rotated easily in respect to the lens flange 4, enabling improved ease in operations in adjusting the focus or adjusting the rotational position.

Note that the structure for enabling the lens barrel 2 to rotate may instead use a recessed portion or a protruding portion, or the like, for catching the hardware, and need not necessarily be of the shape such as in the example.

Moreover, in the imaging device according to the present example, the catch portion that is structured from the protruding portion 2b and the notch portion 2c on the outside of the lens barrel 2 in the radial direction is covered by the front case 1, so as to not be visible on the outside, in the state after the imaging device has been assembled. Because of this, in this imaging device not only is there good convenience in operations in adjusting the focus or adjusting the rotational position, but a structure can be used that produces a state wherein the catch portion is not visible from the outside after assembly, enabling a structure that has superior visual appearance.

Another example according to the present invention will be explained next in reference to the drawings. In the present example, the main point of difference when compared to the previous example is the point that a bracket 9 is disposed in the optical axial rearward direction of the rear case 8. While the present example will be explained below, explanations will be omitted for those structures and functions that are identical to those in the previous example.

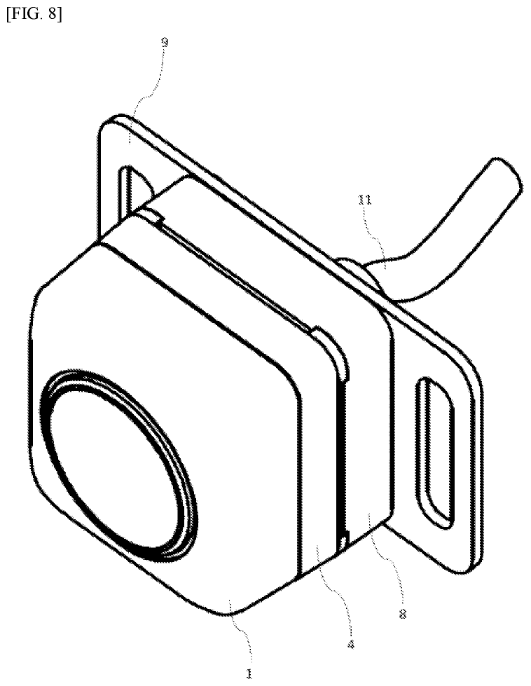

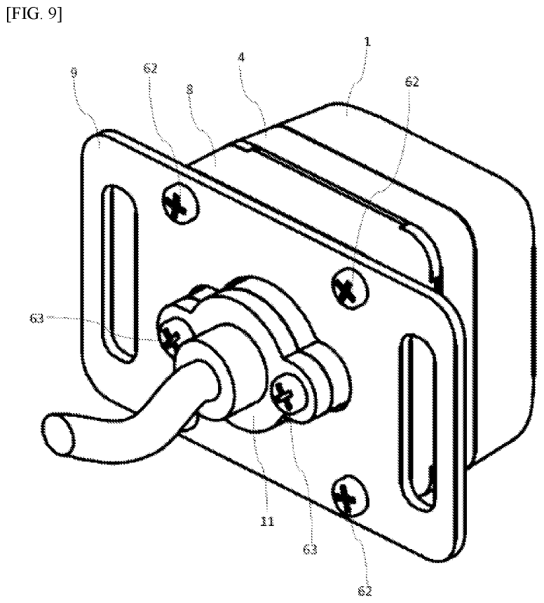

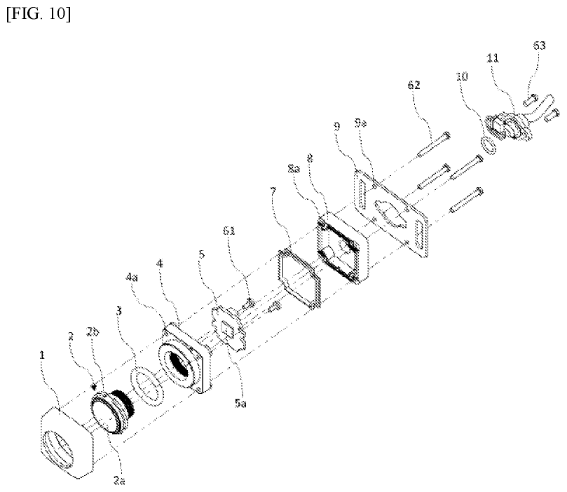

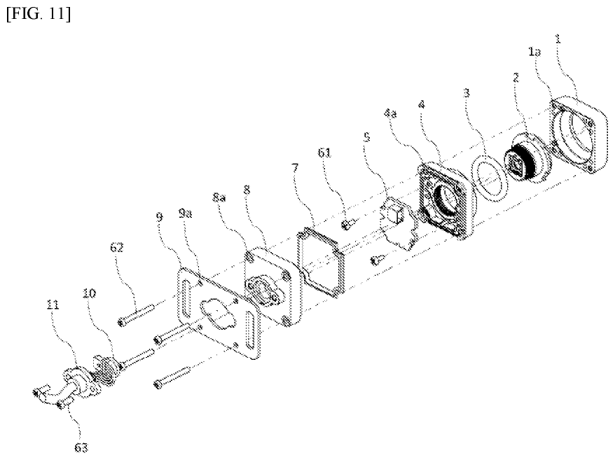

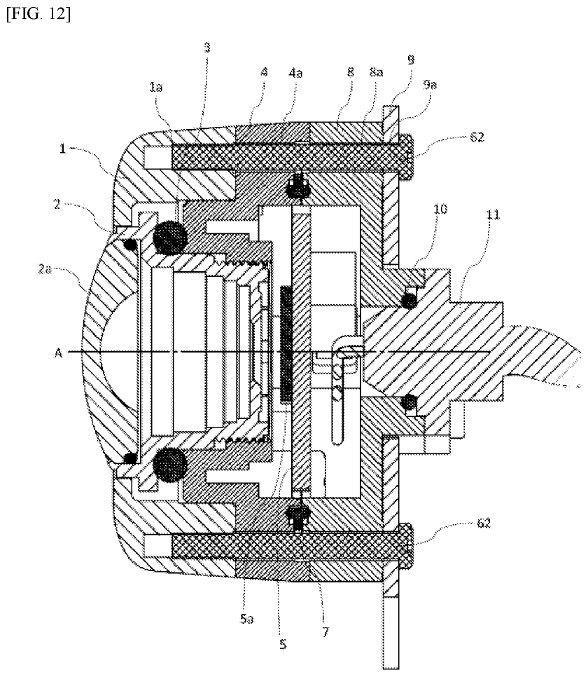

FIG. 8 and FIG. 9 are exterior perspective diagrams of an imaging device according to the present example, wherein FIG. 8 is a diagram seen from the front side and FIG. 9 is a diagram seen from the rear side. FIG. 10 and FIG. 11 are perspective assembly diagrams of an imaging device according to the present example, wherein FIG. 10 is a diagram seen from the front side and FIG. 11 is a diagram seen from the rear side. FIG. 12 is a cross-sectional diagram of the imaging device according to the present example.

As depicted in FIG. 8 through FIG. 12, an imaging device according to the present example is structured including a front case 1, a lens barrel 2, a waterproofing seal 3, a lens flange 4, a substrate 5, a waterproofing seal 7, a rear case 8, a bracket 9, a waterproofing seal 10, a connector 11, and couplings 61, 62, and 63. That is, in the imaging device according to the present example, a bracket 9, a waterproofing seal 10, a connector 11, and a coupling 63 are included, in addition to the structure of the imaging device of the previous example.

<Bracket 9>

The bracket 9 is disposed in the optical axial rearward direction of the rear case 8, and is a member connects to an external device. Specifically, the imaging device according to the present example is connected through the bracket 9 to a vehicle body, or the like. The bracket 9 has a connecting hole 9a into which is inserted the coupling 62, at a position that is further to the outside, in respect to the optical axis, than the waterproofing seal 3, as depicted in FIG. 10 through FIG. 12. The connecting hole 9a is a through hole that extends in a direction that is horizontal (i.e. parallel) to the optical axis. The bracket 9 is connected together with the rear case 8, the lens flange 4, and the front case 1 by the coupling 62 that is inserted into the connecting hole 9a from the optical axial rearward direction.

<Waterproofing Seal 10>

The waterproofing seal 10 is a circular ring-shaped member that is formed from an elastic material, such as rubber, similar to the waterproofing seal 3. The waterproofing seal 10 is disposed between the connector 11 and the rear case 8 so as to prevent the incursion of liquids, such as water, from the outside, through coupling together the connector 11 and the rear case 8 without a gap.

<Connector 11>

The connector 11 is disposed to the rear of the bracket 9 in the optical axial rearward direction, and connected to the rear case 8 through a coupling 63. The connector 11 includes a signal line, and the like, for outputting image data to the external device to which the imaging device is attached.

In the imaging device according to the present example, as described above, a bracket 9 that is connected together with the front case 1, the lens flange 4, and the rear case 8, by the coupling 62, is provided, thus enabling a structure that prevents an increase in the number of components while enabling attachment to the external device to which the imaging device is to be attached.

<3. Supplementary Items>

An example according to the present invention was explained in detail above. The explanation above is no more than an explanation of one form of example, and the scope of the present invention is not limited to this form of example, but rather is interpreted broadly, in a scope that can be understood by one skilled in the art.

For example, the front case 1 and rear case 8, explained in the examples, are not limited to the configurations depicted in the examples. For example, the shape may instead be one wherein the front case 1 is a plate-shaped member that forms a plane that is essentially perpendicular to the optical axial direction, with the rear case 8 having a plate-shaped member, formed in a plane that is essentially perpendicular to the optical axial direction, and side faces that protrude in the optical axial forward direction from the outer edge portion of the plate-shaped member. That is, the front case 1 and the rear case 8 may employ arbitrary shapes that form a case through connecting together. Moreover, the front case 1 and rear case 8 may be formed from a material other than resin.

Additionally, in the imaging devices according to the examples, the front case 1 had a coupling groove 1a; however, the coupling groove 1a may instead be a connecting hole that passes through the front case 1. However, the use of a structure wherein the front case 1 has a coupling groove 1a that is closed one side, rather than passing through, produces a structure that improves the waterproofing performance.

The present invention can be used suitably for imaging devices, or the like, for vehicle mounting.

1. An imaging device, comprising:
a lens barrel holding a lens group;
a lens flange connected to the lens barrel;
a front case;
a rear case, disposed further in an optical axial rearward direction than the front case, containing the lens barrel together with the front case;
a waterproofing seal, disposed between the front case and the lens flange, between the rear case and the lens flange, or between the lens barrel and the lens flange; and
a coupling connecting together the front case, the rear case, and the lens flange, at a position that is to the outside, in respect to the optical axis, of the waterproofing seal.

2. The imaging device as set forth in claim 1, wherein:
the rear case has a first connecting hole;
the lens flange has a second connecting hole;
the front case has a coupling groove; and
the coupling passes through the first connecting hole and the second connecting hole, and is inserted into the coupling groove.

3. The imaging device as set forth in claim 1, wherein:
the lens barrel and the lens flange are separate members; and
the waterproofing seal is disposed between the lens barrel and the lens flange.

4. The imaging device as set forth in claim 3, wherein:
the waterproofing seal is disposed between the lens barrel and the lens flange in the optical axial direction.

5. The imaging device as set forth in claim 1, wherein:
the lens barrel has a recessed portion or a protruding portion on the outside in the radial direction.

6. The imaging device as set forth in claim 5, wherein:
at least one of the recessed portion or the protruding portion of the lens barrel is covered by the front case.

7. The imaging device as set forth in claim 1, further comprising:
a bracket that is connected to an external device, wherein:
the coupling connects together the bracket, along with the front case, the rear case, and the lens flange.
